(19) United States
(12) Patent Application Publication
(10) Pub. No.: US 2019/0333114 A1
(43) Pub. Date: Oct. 31, 2019

(54) SYSTEM FOR DISPLAYING MOBILE OUTDOOR ADVERTISEMENTS

(71) Applicant: Nathan Blake Snyder, Los Angeles, CA (US)

(72) Inventor: Nathan Blake Snyder, Los Angeles, CA (US)

(21) Appl. No.: 16/396,301

(22) Filed: Apr. 26, 2019

Related U.S. Application Data
(60) Provisional application No. 62/662,861, filed on Apr. 26, 2018.

(51) Int. Cl. G06Q 30/02; G09F 21/04

(52) U.S. Cl. CPC G06Q 30/0273; G09F 2021/041; G09F 21/048; G06Q 30/0266

(57) ABSTRACT

A mobile advertisement system that allows individuals to selectively display an advertisement on their vehicle at their option, which system allows the individual a measure of control over which advertisement is displayed on their vehicle, when the advertisement is displayed on their vehicle, and for how long the advertisement is displayed on their vehicle, and which system permits the advertiser to assess and verify that a particular advertisement is displayed on the individual's vehicle, and where (geographically) and for how long the advertisement has been displayed on the individual's vehicle.

### REFERENCE TO PENDING PRIOR PATENT APPLICATION

This patent application claims benefit of pending prior U.S. Provisional Patent Application Ser. No. 62/662,861, filed Apr. 26, 2018 by Nathan Blake Snyder for MOBILE OUTDOOR BILLBOARDS (Attorney's Docket No. NATE-1 PROV), which patent application is hereby incorporated herein by reference.

### FIELD OF THE INVENTION

This invention relates to a novel system for displaying mobile outdoor advertisements in general, and more particularly to a novel system for displaying mobile outdoor advertisements on the vehicles of participating individuals.

### BACKGROUND OF THE INVENTION

Advertisements on commercial vehicles (e.g., taxis, trucks, buses, trains, etc.) have a long history in the marketplace. Such mobile advertisements are typically purchased in bulk by the advertiser and are put on a mobile fleet of vehicles for a contractually-arranged time period. By way of example but not limitation, an advertiser may arrange for a particular advertisement to be displayed on a fleet of several hundred taxis for a period of several months. In this way, the advertisement is seen by many people during regular use of the commercial vehicles carrying the advertisement (e.g., by taxi customers, bus passengers, people walking on the street as the vehicles move by, etc.).

It is also common for small business owners to place an advertisement on the outside of their own vehicle, communicating a message (e.g., an advertisement, contact information, etc.) about their particular business. By way of example but not limitation, such small business vehicle messages typically include advertisements and/or contact information for lawn care services, construction services, plumbing services, housekeeping businesses, etc.

However, as traditional for-hire taxis and other vehicles have been displaced by part-time “rideshare” transportation platforms (e.g., Uber, Lyft, etc.), traditional for-hire vehicles have been replaced by the vehicles of private individuals, which vehicles are typically used in a commercial sense for only a portion of the day. By way of example but not limitation, private individuals who drive part-time for such rideshare transportation platforms generally use their own vehicles when driving for a rideshare transportation platform (which part-time work is as simple as activating a software application program, or “App”, on their smartphone). As such, these private individuals frequently switch between using their vehicles for commercial rideshare transportation platforms and using their vehicles for private use. For this reason, private individuals are generally not amenable to placing an advertisement on their vehicle where the advertisement is to be maintained on the vehicle for a long (e.g., days, weeks, months, etc.) period of time, because the individuals typically do not wish to display advertisements on their vehicle when they are using their vehicle for private use.

Additionally, individuals may wish to have a degree of control over which particular advertisement is displayed on their private vehicle, or at least the option to refuse to display certain advertisements on their private vehicle.

Furthermore, even if individuals participating in rideshare platforms were amenable to displaying advertisements on their vehicle, advertisers would still need a simple and effective means to verify that the advertisement is being displayed on the vehicle, and preferably also a means for tracking exactly where and when the advertisement is displayed on the vehicle.

Thus there is a need for a new and improved mobile advertisement system that allows individuals to selectively display an advertisement on their vehicle at their option, which system allows the individual a measure of control over which advertisement is displayed on their vehicle, when the advertisement is displayed on their vehicle, and for how long the advertisement is displayed on their vehicle, and which system permits the advertiser to assess and verify that a particular advertisement is displayed on the individual's vehicle, and where (geographically) and for how long the advertisement has been displayed on the individual's vehicle.

### SUMMARY OF THE INVENTION

The present invention comprises a new and improved mobile advertisement system that allows individuals to selectively display an advertisement on their vehicle at their option, which system allows the individual a measure of control over which advertisement is displayed on their vehicle, when the advertisement is displayed on their vehicle, and for how long the advertisement is displayed on their vehicle, and which system permits the advertiser to assess and verify that a particular advertisement is displayed on the individual's vehicle, and where (geographically) and for how long the advertisement has been displayed on the individual's vehicle.

In one preferred form of the invention, there is provided a system for displaying mobile outdoor advertisements, said system comprising:

advertisement generation apparatus for generating a mobile outdoor advertisement, said advertisement generation apparatus comprising:
a server comprising a library of advertisements;
a computer for accessing said server, said computer being configured to permit an individual to select an advertisement from said library of advertisements and to download a chosen advertisement to said computer; and
a printer for printing said chosen advertisement to as to generate a printed advertisement;
wherein said printed advertisement comprises a front side and a rear side, and further where said front side of said printed advertisement comprises the advertisement to be displayed, and said rear side of said printed advertisement comprises a digital code; and

advertisement display apparatus for displaying said chosen advertisement on a vehicle, said advertisement display apparatus comprising:
a frame configured to mount to the exterior of a vehicle, said frame being sized to hold said printed advertisement so as to display said front side of said printed advertisement;
a camera for reading said digital code on said printed advertisement;
a global positioning system (GPS) unit for collecting geographic data concerning the location and movement of said frame;
a central processing unit (CPU) for processing data received from said camera and geographic data received from said global positioning system (GPS) unit; and
a wireless transceiver for transmitting data from said central processing unit (CPU) to said server;

wherein said server is configured to store and/or manipulate data received from said advertisement display apparatus.

In another preferred form of the invention, there is provided a system for generating a mobile outdoor advertisement, said system comprising:

a server comprising a library of advertisements; and

a computer for accessing said server, said computer being configured to permit an individual to select an advertisement from said library of advertisements so as to generate a printed advertisement;

wherein said printed advertisement comprises a front side and a rear side, and further where said front side of said printed advertisement comprises the advertisement to be displayed, and said rear side of said printed advertisement comprises a digital code comprising data linked to said printed advertisement and the individual.

In another preferred form of the invention, there is provided a system for displaying mobile outdoor advertisements, said system comprising:

a server;

a printed advertisement comprising a front side and a rear side, said front side of said printed advertisement comprising the advertisement and said rear side of said printed advertisement comprising a digital code;

a frame configured to mount to the exterior of a vehicle, said frame being sized to hold said printed advertisement so as to display the front side of said printed advertisement;

a camera for reading said digital code on said printed advertisement;

a global positioning system (GPS) unit for collecting geographic data concerning the location and movement of said frame;

a central processing unit (CPU) for processing data received from said camera and geographic data received from said global positioning system (GPS) unit; and

a wireless transceiver for transmitting data from said central processing unit (CPU) to said server;

wherein said server is configured to calculate compensation for the individual based on data received from said central processing unit (CPU).

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing a novel system for generating a mobile advertisement;

FIG. 2 is a schematic view of a novel mobile advertisement formed in accordance with the present invention;

FIGS. 3-5 are schematic views showing one preferred form of a novel system for displaying and tracking a mobile advertisement mounted to a vehicle;

FIG. 6 is a schematic view showing another preferred form of a novel system for displaying and tracking a mobile advertisement mounted to a vehicle; and

FIGS. 7-14 are schematic views showing exemplary screen displays provided in accordance with the present invention.

### DETAILED DESCRIPTION OF THE PREFERRED EMBODIMENTS

The present invention comprises a new and improved mobile advertisement system that allows individuals to selectively display an advertisement on their vehicle at their option, which system allows the individual a measure of control over which advertisement is displayed on their vehicle, when the advertisement is displayed on their vehicle, and for how long the advertisement is displayed on their vehicle, and which system permits the advertiser to assess and verify that a particular advertisement is displayed on the individual's vehicle, and where (geographically) and for how long the advertisement has been displayed on the individual's vehicle.

More particularly, the present invention comprises a novel system for generating and printing a mobile advertisement for an individual, and a novel system for displaying the mobile advertisement on a moving vehicle, which system allows the individual a measure of control over which advertisement is displayed on their vehicle, and which system permits the advertiser to assess and verify that a particular advertisement is displayed on the individual's vehicle, and where (geographically) and for how long the advertisement has been displayed on the individual's vehicle.

### System for Generating a Mobile Advertisement

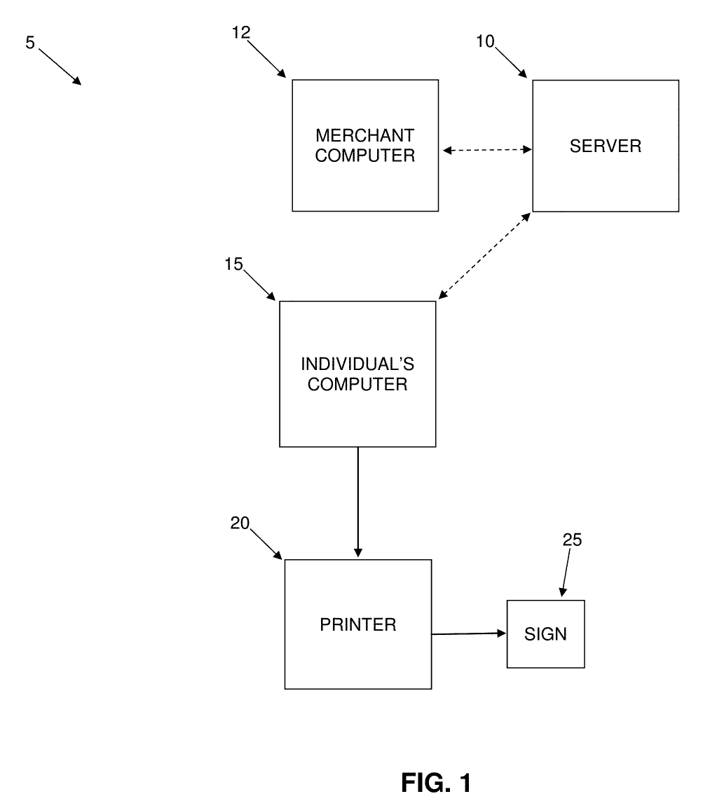

Looking first at FIG. 1, there is shown a novel mobile advertisement generating system 5 for generating and printing a mobile advertisement for display on a moving vehicle. Novel system 5 generally comprises four components: (i) a central server 10 which is preferably connected to the Internet, (ii) a merchant computer 12 which is preferably connected to the Internet and operated by an advertiser (e.g., a merchant generating an advertisement which is to be stored on central server 10, and/or a merchant providing data concerning the compensation for displaying a particular advertisement, as will hereinafter be discussed in further detail), (iii) a individual's computer 15 (which may be a smartphone, tablet, or other computing device) which is preferably connected to the Internet and operated by an individual who will display an advertisement on their vehicle, and (iv) a printer 20 for printing a mobile advertisement 25 (sometimes hereinafter referred to as a “sign”).

More particularly, central server 10 comprises a database comprising a library of formatted mobile advertisements 25 which may be uploaded to central server 10 by advertisers using merchant computers 12, and thereafter selected by individuals using their computers 15.

More particularly, advertisers may use merchant computers 12 to upload advertisements for individuals to select for displaying on their vehicles. In addition, advertisers may also use merchant computers 12 to upload compensation information informing individuals of the compensation they will receive for displaying a selected advertisement on their vehicle. By way of example but not limitation, this compensation information generally includes information concerning how compensation is calculated (e.g., the compensation for displaying a particular advertisement, the compensation per mile driven, the compensation for displaying the advertisement in high population-density areas, etc.).

Note that this compensation information may also include information concerning non-monetary compensation incentives. By way of example but not limitation, merchants may offer compensation incentives (e.g., a chance to meet a “star”, a chance to receive autographed mementos from persons of note, a chance to attend a movie premiere or other exclusive event, etc.) to the individual displaying a particular advertisement if certain thresholds for displaying a particular advertisement are met. Such thresholds for non-monetary compensation incentives may comprise non-monetary compensation incentives for displaying specific advertisements, non-monetary compensation incentives per mile driven, non-monetary compensation for displaying the advertisement in high population-density areas, etc.

Individuals may use their computers 15 to select a particular mobile advertisement 25 from the library of formatted mobile advertisements 25 on server 10 and to print out that mobile advertisement 25 using printer 20. For this purpose, computer 15 is preferably provided with appropriate software to enable a participating individual to select the specific advertisement stored on server 10 which is to be displayed on the individual's vehicle, and to print out the specific advertisement using printer 20. In a preferred form of the invention, the individual logs in to server 10 (e.g., via a web site which is running the database containing the library of mobile advertisements that the individual may select from), selects which specific mobile advertisement the individual wishes to display on their vehicle, and then prints out (e.g., on an 8.5″×11″ sheet of material) that mobile advertisement 25 using printer 20.

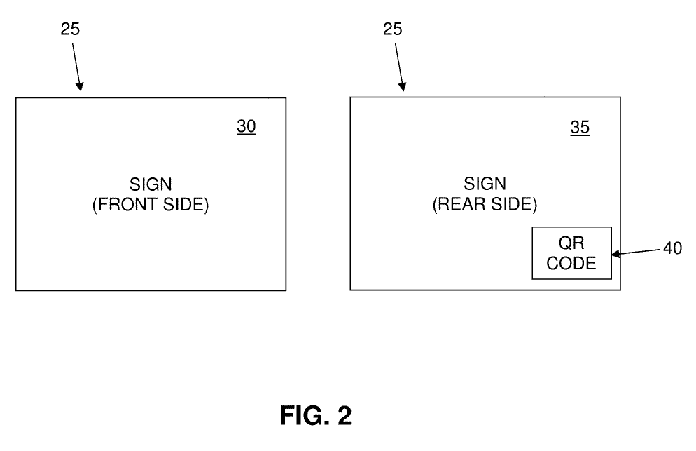

Looking now at FIG. 2, printed mobile advertisement 25 generally comprises a front side 30 and a rear side 35. Front side 30 of mobile advertisement 25 carries the advertisement image (i.e., the “advertisement”) which is to be displayed on the individual's vehicle, and rear side 25 of mobile advertisement 25 carries a digital code 40 (e.g., a bar code, a QR code, etc.) which encodes the advertisement's unique advertisement ID. Digital code 40 may also encode the individual's unique user ID, and/or include a color verifier to validate the printing quality of the printed advertisement image, and/or encode or include various other information.

Once the individual has generated and printed out mobile advertisement 25, the individual can display the mobile advertisement 25 on their vehicle, as will hereinafter be discussed in further detail.

### System for Displaying and Tracking a Mobile Advertisement Mounted to a Vehicle

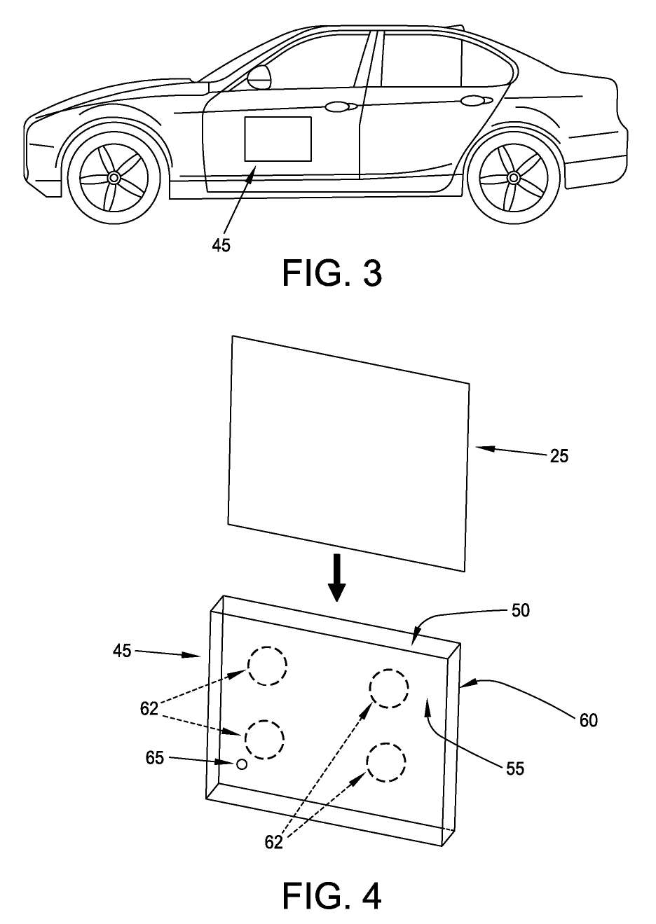

Looking next at FIGS. 3 and 4, the present invention also comprises a novel frame 45 for mounting mobile advertisement 25 to the exterior of a vehicle, as will hereinafter be discussed in further detail.

More particularly, novel frame 45 generally comprises a top-loading pocket 50 having a transparent outward-facing surface 55 and a vehicle-facing surface 60. A top flap (not shown) may be provided for sealing mobile advertisement 25 within top-loading pocket 50 so as to protect mobile advertisement 25 from the elements (e.g., from rain, snow, etc.). Frame 45 is preferably configured to mount to the exterior of the vehicle, e.g., via one or more magnetic mounts 62 disposed on vehicle-facing surface 60.

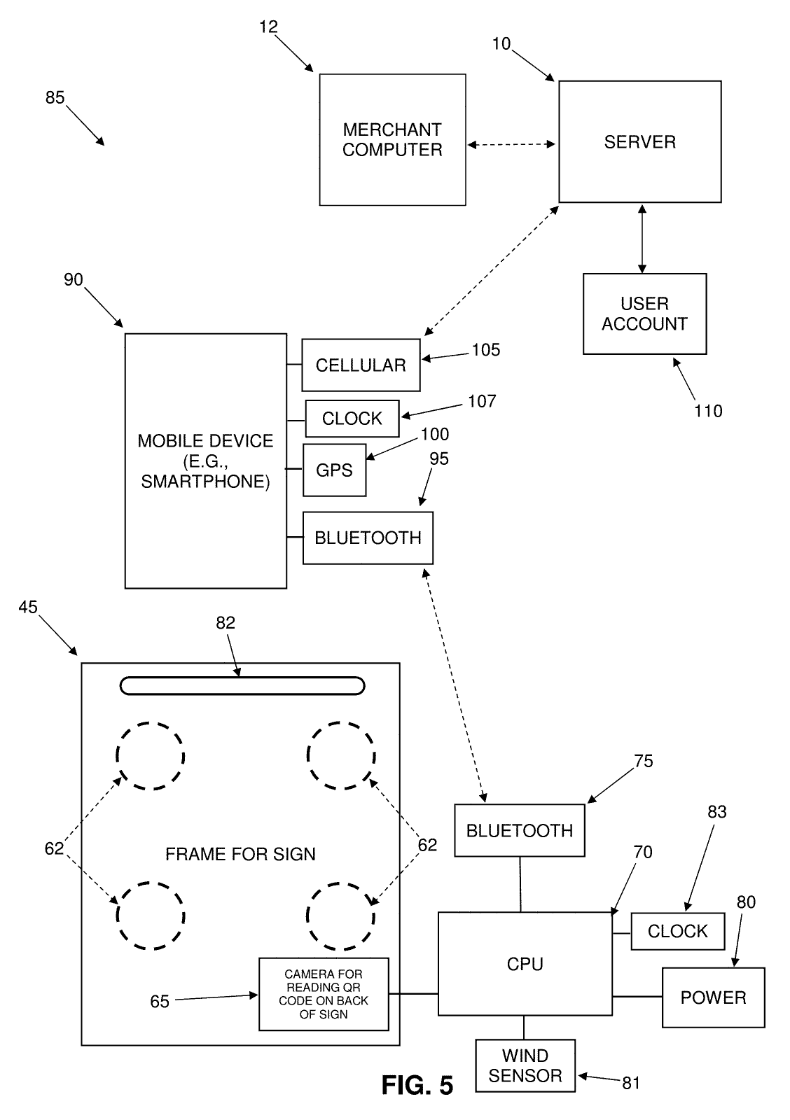

Looking now at FIGS. 4 and 5, novel frame 45 also comprises at least one camera 65 disposed on vehicle-facing surface 60 so as to read digital code 40 (printed on rear side 35 of the mobile advertisement 25) when mobile advertisement 25 is disposed in pocket 50 of frame 45, whereby to allow for identification of the advertisement's unique advertisement ID, and/or to allow for identification of the individual's unique user ID, and/or to allow the color verifier to validate the quality of the advertisement image, and/or to allow for identification of other information encoded in or included in digital code 40, as will hereinafter be discussed in further detail.

Frame 45 also comprises a central processing unit (CPU) 70, a wireless transmitter/receiver (e.g., a Bluetooth transmitter/receiver) 75, and a power source 80 (e.g., a battery, solar cell, etc.). Note that where power source 80 comprises a rechargeable battery, power source 80 may also comprise a connector (not shown) for connecting power source 80 to a charger (not shown) so as to charge power source 80 from an external source (e.g., from an AC wall plug).

If desired, frame 45 may also comprise a wind sensor 81 that can be used to verify that frame 45 is mounted to the exterior of a moving vehicle (as opposed to being located in the trunk of a moving vehicle).

Furthermore, if desired, frame 45 may also comprise means for lighting up a mobile advertisement 25 that is disposed in pocket 50 of frame 45 (e.g., such as when the mobile advertisement is to be displayed in low light conditions). By way of example but not limitation, one or more light emitting diodes (LEDs) 82 (or other light sources) may be integrated into frame 45 for lighting up a mobile advertisement that is disposed in pocket 50 of frame 45, and/or vehicle-facing surface 60 of frame 45 may comprise an electroluminescent sheet for lighting up a mobile advertisement 25 that is disposed in pocket 50 of frame 45, etc.

If desired, frame 45 may also comprise a clock 83 for providing real-time time and date data to central processing unit (CPU) 70, as will hereinafter be discussed in further detail.

In a preferred form of the invention, camera 65, CPU 70, transmitter/receiver 75, power source 80, wind sensor 81, light source 82 and/or clock 83 are preferably connected together on frame 45 so as to be capable of acquiring data regarding mobile advertisement 25 and its display, and for transmitting such data between frame 45 and a mobile device (e.g., a smartphone) disposed inside the vehicle, as will hereinafter be discussed in further detail.

More particularly, in a preferred form of the invention, and looking now at FIG. 5, there is shown a novel system 85 for facilitating tracking of at least one of (i) the instantaneous (i.e., current) location of mobile advertisement 25 at a given moment, (ii) the instantaneous time and date (e.g., the real-time time and date data provided by clock 83) that the mobile advertisement 25 is displayed, (iii) whether the mobile advertisement 25 is stationary or moving, (iv) where (i.e., geographically) the mobile advertisement 25 has been displayed (i.e., where the vehicle has moved while displaying the mobile advertisement 25 over a particular period of time), and (v) the total amount of time that the mobile advertisement 25 has been displayed on the vehicle.

More particularly, novel system 85 generally comprises the aforementioned frame 45 for displaying mobile advertisement 25 on the exterior of the vehicle, a mobile device 90 (e.g., the individual's personal smartphone), and the aforementioned server 10.

In addition to comprising appropriate electronics, power source and a user interface, mobile device 90 (e.g., smartphone 90) also preferably comprises a wireless local transmitter/receiver (e.g., a Bluetooth transmitter/receiver) 95 for communicating with transmitter/receiver 75 of frame 45, a global positioning system (GPS) unit 100 for tracking the geographic position of mobile device 90 (and hence the geographic position of mobile advertisement 25), a global transmitter/receiver 105 (e.g., a cellular transceiver) for wirelessly transmitting data from mobile device 90 to server 10, and a clock 107 for providing real-time time and date data to server 10, as will hereinafter be discussed in further detail. It will be appreciated that smartphones currently provide all of these features (e.g., a Bluetooth transmitter/receiver, a GPS unit, a cellular transceiver, a clock, etc.). Note that where mobile device 90 comprises a smartphone, clock 83 of frame 45 may be omitted inasmuch as system 85 may use clock 107 of mobile device 90 (rather than clock 83 of frame 45) for obtaining real-time time and date data.

Mobile device 90 further comprises appropriate software for facilitating connection and data transfer between frame 45, mobile device 90 and server 10, as will hereinafter be discussed in further detail. More particularly, mobile device 90 (e.g., smartphone 90) preferably comprises a software application (sometimes hereinafter referred to as a “Smartphone App”) which is downloaded and installed on the individual's mobile device 90. The Smartphone App connects to CPU 70 of frame 45 via a wireless connection between local transmitter/receiver 95 of mobile device 90 and transmitter/receiver 75 of frame 45 (e.g., via a Bluetooth connection) so as to create a short-range wireless link between mobile device 90 and frame 45, whereby to allow data to be uploaded from frame 45 to mobile device 90. The Smartphone App also (e.g., simultaneously) connects to server 10 via global transmitter/receiver 105 (e.g., a cellular transceiver, WiFi, etc.), whereby to facilitate data transfer from mobile device 90 to server 10. Such data comprises confirmation that mobile advertisement 25 is properly presented in frame 45 (e.g., from information acquired by camera 65), confirmation that the vehicle is moving (e.g., from GPS unit 100), confirmation regarding the number of miles driven while the mobile advertisement is displayed in frame 45 (e.g., from GPS unit 100), the geographic location in which the mobile advertisement is being displayed (e.g., from GPS unit 100), etc. It will be appreciated that mobile device 90 need not directly connect to server 10, but may instead connect to the Internet and, in turn, connect to server 10 via the Internet, as will be apparent to one skilled in the art.

Server 10 preferably comprises appropriate software for linking data received from the individual's mobile device 90 with a user account 110 linked to that particular individual so as to enable calculation of the appropriate compensation for the individual displaying mobile advertisement 25 on the individual's vehicle, as will hereinafter be discussed in further detail. Server 10 may also include a clock (not shown) for providing real-time time and date data, and/or for verifying real-time time and date data provided by clock 83 of frame 45 and/or clock 107 of mobile device 90. Server 10 preferably also comprises appropriate software for linking server 10 to merchant computers 12 so that advertisers can download information regarding the display of their advertisements.

### Method for Verifying the Display of a Mobile Advertisement, for Tracking the Time and Movement of the Mobile Advertisement Mounted to Vehicle, and for Calculating Compensation to an Individual for Displaying the Mobile Advertisement

As discussed above, system 85 may be used to collect data concerning when and where a particular mobile advertisement 25 disposed within frame 45 is displayed, as well as transmit that data to server 10 so as to calculate appropriate compensation to the individual for displaying the mobile advertisement.

Inasmuch as the advertiser desires to ensure correct placement and display of the mobile advertisement 25 (as well as to verify that the mobile advertisement 25 is actually displayed while frame 45 is mounted to the individual's vehicle), system 85 also facilitates verification of the correct placement and display of the mobile advertisement 25 within top-loading pocket 50 of frame 45, as well as verification that the mobile advertisement 25 is disposed in top-loading pocket 50 and displayed for the entire period that the individual is operating system 85 (i.e., for the entire period during which the individual claims that they are displaying the mobile advertisement on their vehicle).

More particularly, and still looking at FIG. 5, when the user activates system 85 (e.g., by placing a mobile advertisement 25 in top-loading pocket 50 of frame 45, mounting frame 45 to the exterior of their vehicle, and using the Smartphone App on mobile device 90 to advise server 10 that the mobile advertisement 45 is being displayed), camera 65 on frame 45 reads digital code 40 printed on the rear side 35 of mobile advertisement 25 and transmits the data encoded in digital code 40 to server 10 (e.g., via the aforementioned wireless connections between frame 45, mobile device 90 and server 10, with the Smartphone App on mobile device 90 serving as an intermediary for facilitating the connection and data transfer). Mobile device 90 of system 85 also begins reporting to server 10 the location of the vehicle carrying frame 45 (and hence the location of mobile advertisement 25) via the data obtained from GPS unit 100. Mobile device 90 may also report other data to server 10 (e.g., movement data from wind sensor 81, time and date data from clock 83 and/or clock 107, etc.). Data transmitted to server 10 is received and processed by appropriate software on server 10 (sometimes hereinafter referred to as “Base Station Software”). The Base Station Software on server 10 receives the data transmitted by the Smartphone App and (i) identifies (i.e., based on the data provided by digital code 40 read by camera 65) the advertisement's unique advertisement ID, the individual's unique user ID, and/or the color verifier, (ii) verifies that the mobile advertisement 25 is correctly situated in top-loading pocket 50 of frame 45 and verifies that the mobile advertisement 25 remains in pocket 50 of frame 45 for the entire period of time that system 85 is active, (iii) confirms that the vehicle carrying frame 45 is moving and identifies the geographic region through which the vehicle is moving, and (iv) calculates the compensation which is due to the individual for displaying mobile advertisement 25 on their vehicle.

By way of example but not limitation, the compensation to the individual for displaying mobile advertisement 25 may be based on (i) which particular mobile advertisement is being displayed by the individual, and (ii) various criteria associated with how the advertisement has been displayed to the public. By way of example but not limitation, some of the criteria associated with how the mobile advertisement 25 is displayed to the public may include the particular locations where the mobile advertisement 25 was displayed to the public (as determined by GPS unit 100), the total amount of time that the mobile advertisement 25 was displayed to the public (e.g., as calculated by data received from clock 83 and/or clock 107), the absolute time that the mobile advertisement 25 was displayed to the public (e.g., as calculated by data received from clock 83 and/or clock 107), the speed at which the mobile advertisement was moving while displayed to the public (as determined by GPS unit 100), the number of miles driven while displaying the mobile advertisement 25 (as determined by GPS unit 100), etc.

### Additional Constructions

It should be appreciated that variations of the foregoing system are also possible and fall within the scope of the present invention.

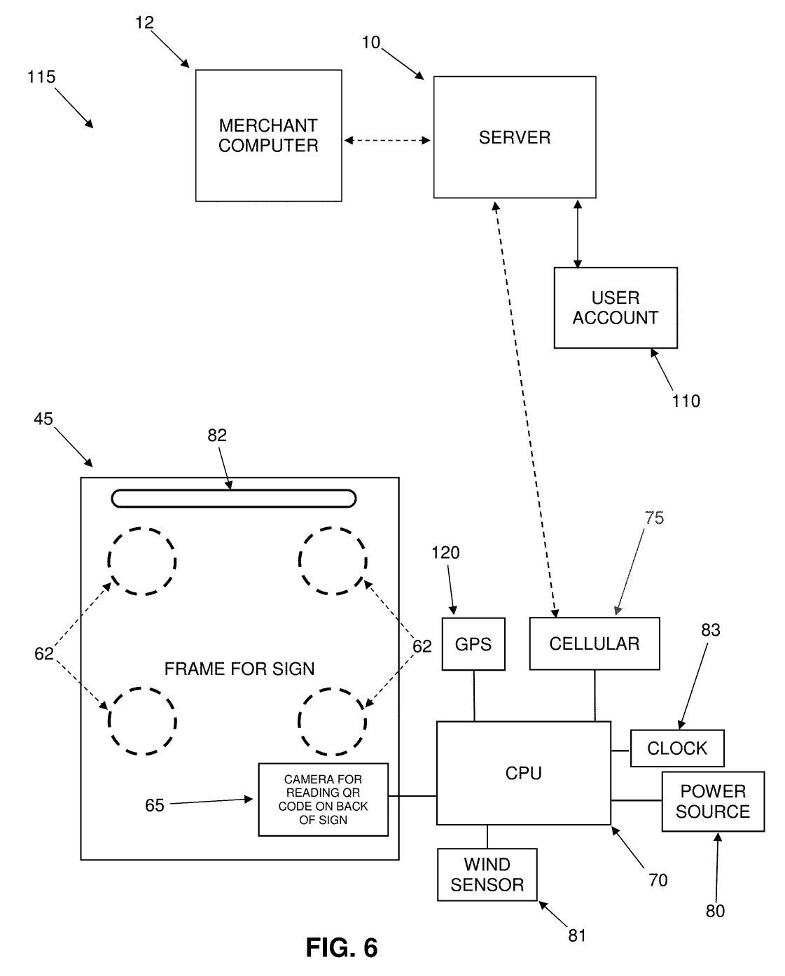

By way of example but not limitation, and looking now at FIG. 6, there is shown an alternative system 115 for collecting data concerning when and where a particular mobile advertisement 25 disposed within frame 45 is displayed, as well as for transmitting that data to server 10 so as to calculate appropriate compensation to the individual for displaying the mobile advertisement.

System 115 is generally similar to the aforementioned system 85 discussed above, however, system 115 omits mobile device 90 and frame 45 includes some of the components provided by mobile device 90 and frame 45 communicates directly with server 10 via wireless communication. By way of example but not limitation, in this form of the invention, transmitter/receiver 75 of frame 45 may comprise a cellular transceiver for communicating directly with server 10. Furthermore, frame 45 may comprise a global positioning system (GPS) unit 120 for providing appropriate position and movement data to server 10 that may be used for calculating the extent to which the vehicle is moving and the specific geographic locations through which the vehicle moves, both of which are important criteria for appropriately calculating the compensation due to the individual. And clock 83 of frame 45 may provide time and date data to server 10 that may be used for calculating the extent to which the mobile advertisement is displayed and hence the compensation due to the individual. In this respect, system 115 operates in the same manner as the aforementioned system 85 but does not require an intermediary mobile device 90 (e.g., a smartphone 90), since all of the components and functions provided by the mobile device 90 of system 85 are incorporated into frame 45 with system 115.

Additionally, if desired, a print quality verification marker may be printed on rear side 35 of mobile advertisement 25 so as to permit camera 65 to verify the print quality and/or color quality of mobile advertisement 25 (e.g., at the same time that camera 65 reads digital code 40). To this end, the print quality verification marker may be formed as a part of the digital code 40, may comprise the digital code 40, may be placed adjacent to digital code 40, etc.

It should also be appreciated that, if desired, frame 45 may be sized to receive a single mobile advertisement 25 that is spread out over a plurality of sheets (e.g., four sheets) printed on standard 8.5″ by 11″ paper so as to display a large advertisement. With this form of the invention, frame 45 is suitably enlarged so as to receive multiple sheets of paper and may comprise appropriate pockets for keeping the multiple sheets of paper properly separated and in correct position relative to one another, as will be apparent to one skilled in the art in view of the present disclosure. Furthermore, if desired, where frame 45 is configured to hold a plurality of sheets of paper (e.g., so as to display a single mobile advertisement spanning multiple sheets of paper), vehicle-facing surface 60 may comprise a plurality of cameras 65 (e.g., one camera 65 suitably placed for each sheet of paper to be placed in frame 45), whereby to allow for verification that all of the sheets are properly mounted in frame 45.

Alternatively, if desired, frame 45 may be sized to simultaneously receive a plurality of mobile advertisements 25 (e.g., four) printed on standard 8.5″ by 11″ paper in the manner discussed above, so that frame 45 simultaneously displays multiple mobile advertisements 25.

In still another form of the invention, frame 45 may be sized to receive a single, larger mobile advertisement 25 (e.g., a poster-sized mobile advertisement that is, for example, 24″ by 36″). With this form of the invention, due to the larger size of the mobile advertisement 25 and the fact that individuals typically do not have the equipment for printing a larger-sized mobile advertisement 25, the mobile advertisement 25 may be digitally transmitted to a commercial printer and then mailed out to, or sent by courier to, the individual (e.g., after the individual selects the particular mobile advertisement 25 in the manner discussed above), or the individual may pick up the printed larger-sized mobile advertisement 25 from another location (e.g., a distribution point).

Additionally, if desired, system 85 and/or system 115 may include means for verifying that frame 45 is mounted to the outside of the vehicle. By way of example but not limitation, frame 45 may comprise mechanical means (e.g., a push button, the aforementioned wind sensor 81, an optical sensor, etc.) for verifying the placement of frame 45 on the vehicle, and/or the Smartphone App may require that the individual verify placement of frame 45 on the vehicle (e.g., by requiring the individual to take a photo of frame 45 mounted to the individual's vehicle using mobile device 90, etc.).

Additionally, if desired, system 85 and/or system 115 may include a digital advertisement held by the frame 45 that can change the advertisement that is displayed in the frame without user intervention. By way of example but not limitation, such a digital advertisement may comprise a liquid crystal display (LCD), a light-emitting diode (LED) display, an organic light-emitting diode (OLED) display, etc., and the mobile advertisement may be “delivered” from server 10 to frame 45 via transmitter/receiver 105 and transceivers 95 and 75 (in the case of system 85 shown in FIG. 5) or just transceiver/receiver 105 (in the case of system 115 shown in FIG. 6).

### Merchant Portal for Interacting with Server 10

As discussed above, in one form the invention, there is provided a merchant computer 12 for uploading mobile advertisements 25 to server 10 and/or for providing compensatory incentives linked to particular mobile advertisements 25 stored on server 10 for the individual to consider when selecting a particular mobile advertisement 25 to display on their vehicle.

To this end, if desired, server 10 may comprise appropriate software for providing a “merchant panel” (e.g., a website interface) where merchants accessing server 10 via their merchant computer 12 can upload particular mobile advertisements 25, set budgets for particular mobile advertisements 25 (e.g., global advertising budgets for particular mobile advertisements 25), provide various compensatory incentives to individuals who select and display particular mobile advertisements 25 on their vehicles, and/or to allow the merchant to track performance of particular mobile advertisements 25 (e.g., to track how often or how many times a particular mobile advertisement 25 has been selected by individuals for display on their vehicle, to track where a particular mobile advertisement 25 has been displayed, etc.).

It should also be appreciated that server 10 may comprise appropriate software for providing an “administrator panel” (e.g., a website interface) to allow an administrator to access data obtained from systems 85, 115 during displaying of mobile advertisements 25, facilitate compensation between merchants and individuals (and the administrator), activate or deactivate particular mobile advertisements 25, etc.

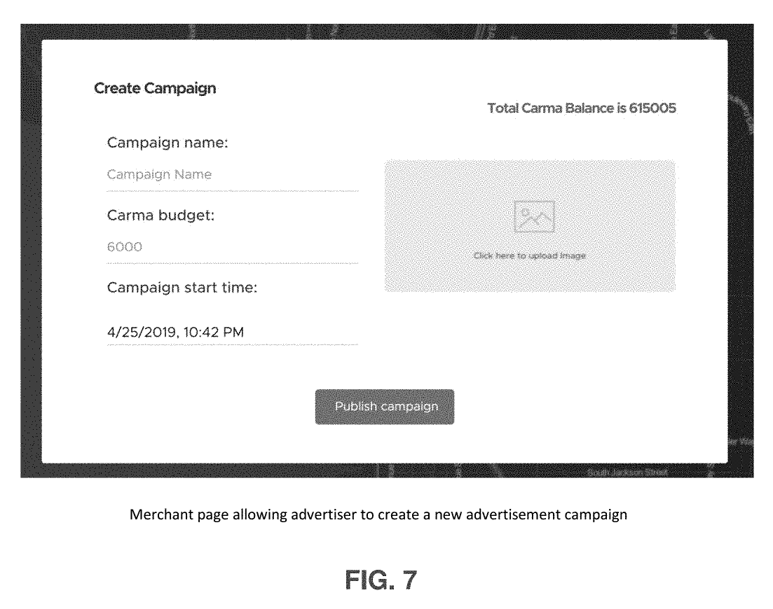

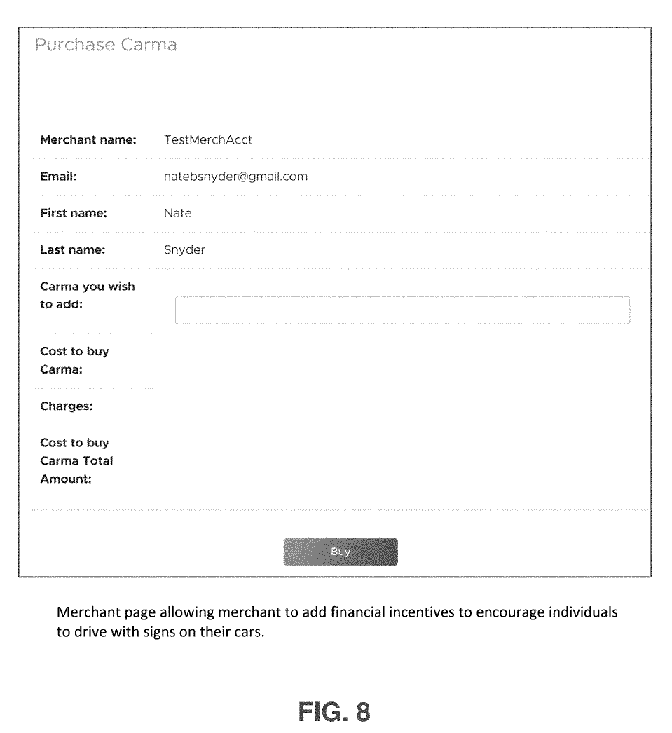

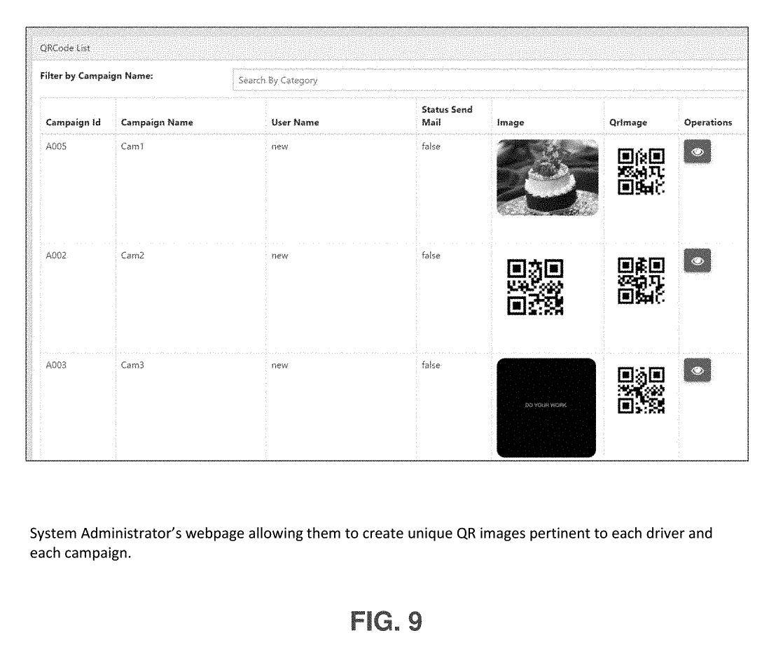

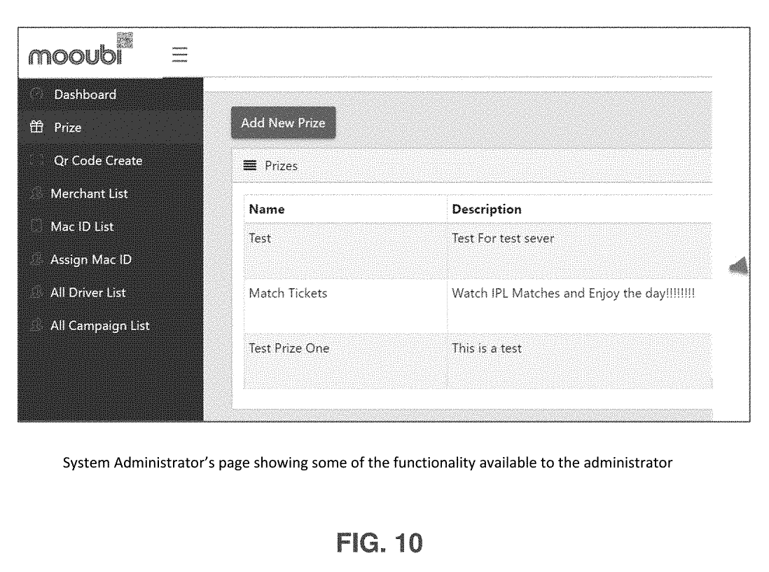

See, for example, FIGS. 7 and 8, which show exemplary merchant portal screen displays; and FIGS. 9 and 10, which show exemplary system administrator screen displays.

### User Portal for Interacting with Server 10

As discussed above, in one form the invention, there is provided an individual's computer 15 for allowing the individual to select a mobile advertisement 25 from server 10 to be displayed on their vehicle and for printing that advertisement using printer 20.

To this end, if desired, server 10 may comprise appropriate software for providing a “user panel” (e.g., a website interface) where individuals accessing server 10 via their individual computer 15 can select a particular mobile advertisement 25 to be displayed and then print that mobile advertisement on their printer 20.

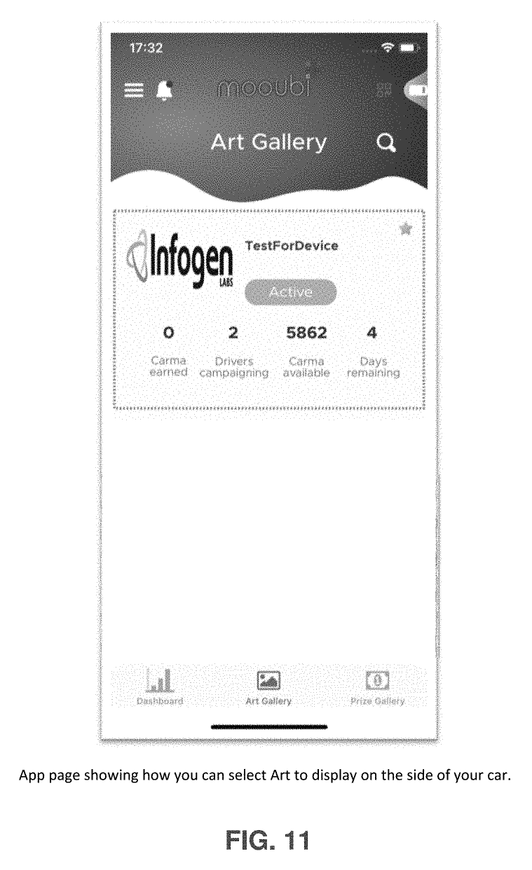

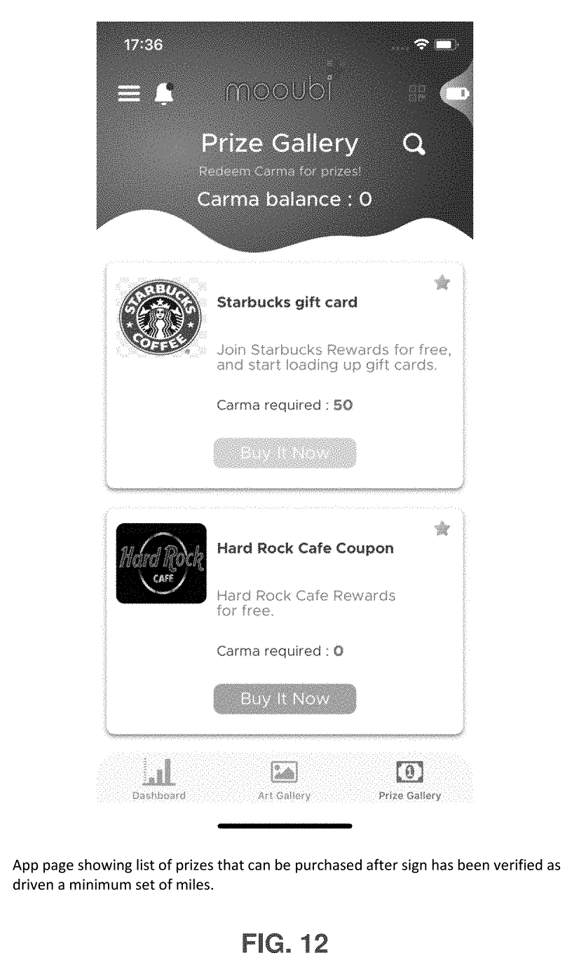

See, for example, FIGS. 11 and 12, which show exemplary user portal screen displays.

### Smartphone Portal for Interacting with Server 10

As discussed above, in one form the invention, there is provided a mobile device 90 (e.g., a smartphone) for transmitting data regarding the display of a mobile advertisement 25 to server 10.

To this end, if desired, mobile device 90 may comprise appropriate software for providing a “smartphone portal” (e.g., a Smartphone App) where individuals can access data at server 10 regarding their display of a particular mobile advertisement 25 on their vehicle (e.g., total compensation earned, information about compensatory incentives being earned, etc.).

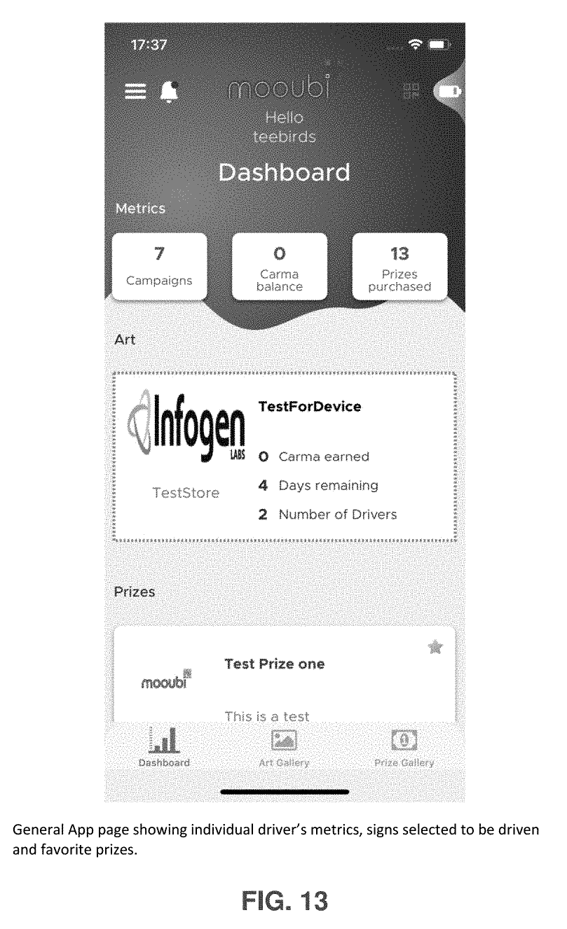

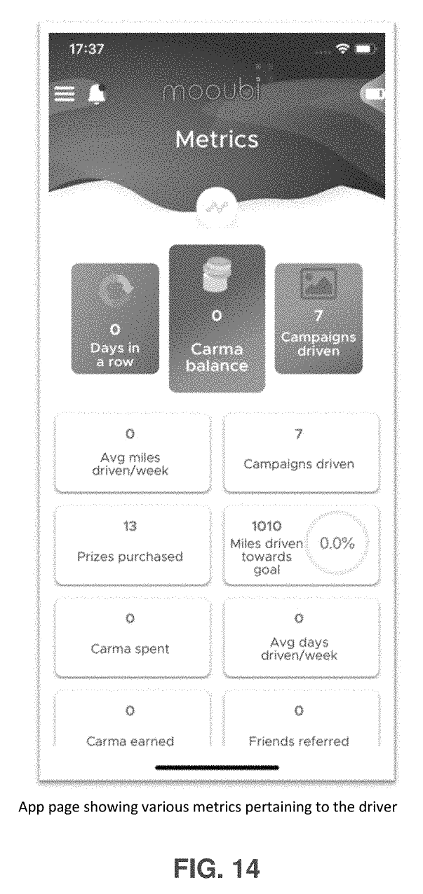

See, for example, FIGS. 13 and 14, which show exemplary smartphone portal screen displays.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A system for displaying mobile outdoor advertisements, said system comprising:
advertisement generation apparatus for generating a mobile outdoor advertisement, said advertisement generation apparatus comprising:
a server comprising a library of advertisements;
a computer for accessing said server, said computer being configured to permit an individual to select an advertisement from said library of advertisements and to download a chosen advertisement to said computer; and
a printer for printing said chosen advertisement to as to generate a printed advertisement;
wherein said printed advertisement comprises a front side and a rear side, and further where said front side of said printed advertisement comprises the advertisement to be displayed, and said rear side of said printed advertisement comprises a digital code; and
advertisement display apparatus for displaying said chosen advertisement on a vehicle, said advertisement display apparatus comprising:
a frame configured to mount to the exterior of a vehicle, said frame being sized to hold said printed advertisement so as to display said front side of said printed advertisement;
a camera for reading said digital code on said printed advertisement;
a global positioning system (GPS) unit for collecting geographic data concerning the location and movement of said frame;
a central processing unit (CPU) for processing data received from said camera and geographic data received from said global positioning system (GPS) unit; and
a wireless transceiver for transmitting data from said central processing unit (CPU) to said server;
wherein said server is configured to store and/or manipulate data received from said advertisement display apparatus.

2. A system according to claim 1 wherein at least one of said advertisement display apparatus and said server comprises a clock for providing time and date data.

3. A system according to claim 2 wherein:
said advertisement display apparatus comprises a mobile device;
wherein said global positioning system (GPS) unit, said central processing unit (CPU) and said wireless transceiver for transmitting data from said central processing unit (CPU) to said server are carried by said mobile device; and
said frame further comprises a wireless transceiver for transmitting and receiving data to and from said mobile device.

4. A system according to claim 3 wherein said mobile device further comprises a software application program for facilitating communication and data transfer between (i) said camera, said global positioning system (GPS) unit, and said central processing unit (CPU), and (ii) said server.

5. A system according to claim 4 wherein said server is configured to calculate compensation for use of the system, and further wherein said compensation is calculated using said data transferred from said mobile device.

6. A system according to claim 5 wherein said compensation is calculated using the geographical location where said printed advertisement was displayed as determined from data received from said global positioning system (GPS) unit.

7. A system according to claim 5 wherein said compensation is calculated using the total amount of time that said printed advertisement was displayed as determined from data received from said clock.

8. A system according to claim 5 wherein said compensation is calculated using the speed at which said printed advertisement was moving while said printed advertisement was disposed in said frame as determined from data received from said global positioning system (GPS) unit.

9. A system according to claim 5 wherein said compensation is calculated using the total amount of miles that said vehicle to which said frame is mounted is driven while said printed advertisement was disposed in said frame as determined from data received from said global positioning system (GPS) unit.

10. A system according to claim 5 wherein said server comprises a user account associated with the individual, such that said compensation calculated by said server is recorded in the user account for the individual.

11. A system according to claim 10 wherein said digital code comprises data linking said digital code to at least one of said printed advertisement and said user account.

12. A system according to claim 1 wherein said camera reads said digital code on said printed advertisement to verify that said printed advertisement is correctly mounted in said frame.

13. A system according to claim 12 wherein said camera continuously reads said digital code on said printed advertisement so as to continuously verify that said advertisement is correctly mounted in said frame.

14. A system according to claim 1 wherein said digital code comprises an optical code.

15. A system according to claim 1 wherein said optical code comprises one selected from the group consisting of a barcode and a QR code.

16. A system according to claim 1 wherein said frame is mounted to the vehicle via one or more magnetic mounts.

17. A system according to claim 1 wherein said frame further comprises at least one light source for illuminating said printed advertisement disposed in said frame.

18. A system for generating a mobile outdoor advertisement, said system comprising:
a server comprising a library of advertisements; and
a computer for accessing said server, said computer being configured to permit an individual to select an advertisement from said library of advertisements so as to generate a printed advertisement;
wherein said printed advertisement comprises a front side and a rear side, and further where said front side of said printed advertisement comprises the advertisement to be displayed, and said rear side of said printed advertisement comprises a digital code comprising data linked to said printed advertisement and the individual.

19. A system according to claim 18 wherein said printed advertisement is printed by the individual.

20. A system according to claim 18 wherein said printed advertisement is delivered to the individual.

21. A system according to claim 18 wherein said printed advertisement is delivered to a third party, and further wherein the individual picks up said printed advertisement from said third party.

22. A system for displaying mobile outdoor advertisements, said system comprising:
a server;
a printed advertisement comprising a front side and a rear side, said front side of said printed advertisement comprising the advertisement and said rear side of said printed advertisement comprising a digital code;
a frame configured to mount to the exterior of a vehicle, said frame being sized to hold said printed advertisement so as to display the front side of said printed advertisement;
a camera for reading said digital code on said printed advertisement;
a global positioning system (GPS) unit for collecting geographic data concerning the location and movement of said frame;
a central processing unit (CPU) for processing data received from said camera and geographic data received from said global positioning system (GPS) unit; and
a wireless transceiver for transmitting data from said central processing unit (CPU) to said server;
wherein said server is configured to calculate compensation for the individual based on data received from said central processing unit (CPU).
